(19) United States
(12) Patent Application Publication
(10) Pub. No.: US 2005/0044772 A1
(43) Pub. Date: Mar. 3, 2005

(54) FISH HOOK WITH BAIT ATTACHMENT CLIP

(75) Inventor: Richard S. Lillard II, Miami, OK (US)

Correspondence Address: HOVEY WILLIAMS LLP, 2405 GRAND BLVD., SUITE 400, KANSAS CITY, MO, 64108, US

(73) Assignee: HART TACKLE COMPANY, LLC, Stratford, OK (US)

(21) Appl. No.: 10/604,937

(22) Filed: Aug. 27, 2003

(51) Int. Cl. A01K 83/06

(52) U.S. Cl. 43/44.6

(57) ABSTRACT

Fishing tackle (10) constructed in accordance with the principles of a preferred embodiment of the present invention and configured for coupling to a fishing line (L) to secure a lure (B) thereto for catching fish is disclosed. The illustrated fishing tackle (10) broadly includes a fish hook (12) operable to be coupled to the fishing line (L), a bait-attachment clip (14) coupled to the hook (12), and a flexible sleeve (36) slidably received on the hook (12) and configured to removably couple the bait-attachment clip (14) thereto in an operative position. The bait-attachment clip (14) is configured for quickly and securely clamping the bait (B) to the hook (12). A preferred alternative embodiment (100) is also disclosed wherein the clip (104) is integrally formed with the hook (102) and thus does not utilize the sleeve (36). The inventive combination enables a lure, such as live or artificial bait, to be more readily coupled to the hook in a secure manner that does not impair the lure for example, in the case of live bait, the bait need not be impaled yet prevents the fish from “stealing” the lure off of the hook and allows the lure to be quickly replaced with a different lure at the fisherman's discretion.

### BACKGROUND OF INVENTION

1. Field of the Invention

The present invention relates generally to fishing equipment. More specifically, the present invention concerns fishing tackle for attaching bait to, and catching fish on, a fishing line. The improved tackle includes a fish hook and a bait-attachment clip coupled to the hook for quickly and securely clamping bait to the hook. The inventive combination enables a lure, such as live or artificial bait, to be more readily coupled to the hook in a secure manner that does not impair the lure for example, in the case of live bait, the bait need not be impaled yet prevents the fish from “stealing” the lure off of the hook and allows the lure to be quickly replaced with a different lure at the fisherman's discretion.

2. Discussion of Prior Art

Fishing tackle that couples to the end of a fishing line, such as a line strung through a rod and a reel, for catching fish are known in the art. Virtually all prior art tackle utilize some type of fish hook for catching the fish and some type of lure for causing the fish to bight the hook and/or lure wherein both the hook and lure are coupled to the end of the fishing line. The prior art hooks are variously configured, but all include at least one barbed end for hooking the fish. The prior art lures are variously configured, sized, and shaped (e.g., depending on the type of fish attempted to be attracted), however, all prior art tackle typically either utilize artificial or live bait as the lure. With prior art tackle, the artificial bait is either permanently and/or integrally manufactured with the hook, or in some cases, may be tied to the hook on location, such as is commonly done when fly fishing. With prior art tackle that utilize live bait, the live bait is typically coupled to the hook by impaling the bait on the barbed end of the hook.

These prior art fishing tackle are problematic and subject to several undesirable limitations. For example, the prior art tackle utilizing artificial bait undesirably requires the entire tackle to be removed from the fishing line in order to change the lure being used which typically requires untying a knot in the line, or cutting the line to remove the hook and lure, and then retying a new hook and lure onto the line. This method is undesirably slow and tedious and is subject to poor quality knots that render the hook and lure susceptible to inadvertently coming off the line and becoming lost or unretrievable. The prior art tackle utilizing live bait undesirably requires the live lure to be impaled on the hook, thereby severely limiting the lure's ability to retain its fish-attracting live bait appearance and preventing the lure from being reused. Additionally, even when impaled on the hook, the prior art methods of securing the live bait render the bait undesirably susceptible to being “stolen” off of the hook by a nibbling fish without enabling the fish to be hooked by the hook.

### SUMMARY OF INVENTION

The present invention provides improved fishing tackle that does not suffer from the problems and limitations of the prior art tackle detailed above. The inventive tackle includes a fish hook and a bait-attachment clip coupled to the hook for quickly and securely clamping bait to the hook. The unique combination enables a lure, such as live or artificial bait, to be quickly and easily coupled to the hook and decoupled therefrom to provide readily inter-changing of the lures. The inventive combination couples the lure to the hook in a secure manner that generally prevents fish from taking the lure off of the hook. However, the inventive bait-attachment hook does not impair the lure for example, in the case of live bait, the bait need not be impaled. In a preferred embodiment, the clip is removably coupled to the hook with a flexible sleeve. In a preferred alternative embodiment, the clip is integrally formed with the hook.

A first aspect of the present invention concerns fishing tackle broadly including a fish hook and a bait-attachment clip fixed relative to the hook.

A second aspect of the present invention concerns fishing tackle for coupling a lure to a fishing line. The fishing tackle broadly includes a fish hook operable to be coupled to the fishing line, a clip removably coupled to the hook and including a first and a second jaw, and a sleeve received on the hook and slidable relative to the hook and at least one of the jaws into a retention position wherein the sleeve encircles at least a portion of the hook and at least a portion of the at least one jaw to thereby removably couple the clip to the hook. The first and second jaws are shiftable relative to each other into and out of a clamping position wherein the jaws are adapted to hold the lure.

A third aspect of the present invention concerns a method of baiting a fishing hook. The method broadly includes the steps of coupling a lure-attachment clip to the hook, and clamping a first lure in the clip.

Other aspects and advantages of the present invention will be apparent from the following detailed description of the preferred embodiments and the accompanying drawing figures.

### BRIEF DESCRIPTION OF DRAWINGS

Preferred embodiments of the invention are described in detail below with reference to the attached drawing figures, wherein:

FIG. 1 is a perspective view of fishing tackle constructed in accordance with a preferred embodiment of the present invention and shown tied to a fishing line (in phantom), illustrating the sleeve in the retention position and the bait-attachment clip in the clamping position securing a lure (in phantom);

FIG. 2 is a perspective view of the fishing tackle illustrated in FIG. 1 with the sleeve shown shifting into the retention position (in phantom) and the bait-attachment clip in the clamping position; and

FIG. 3 is a side elevational view of fishing tackle constructed in accordance with a preferred alternative embodiment of the present invention illustrating the bait-attachment clip integrally formed with the fishing hook.

### DETAILED DESCRIPTION

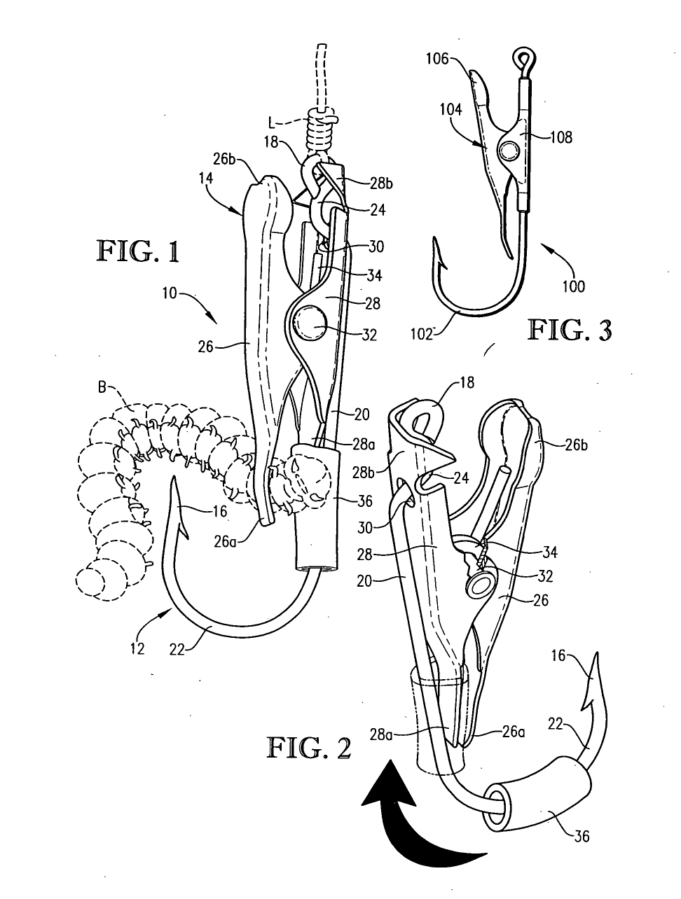

FIG. 1 illustrates fishing tackle 10 constructed in accordance with the principles of a preferred embodiment of the present invention and configured for coupling to a fishing line L to secure a lure B thereto for catching fish. The illustrated line L is conventional fishing line that is rigged through a standard rod and reel (not shown) in any suitable manner known in the art so that the free end can be cast out and selectively reeled in. The illustrated tackle 10 is secured to the free end of the line L with a traditional fisherman's knot. However, the present invention can be used with virtually any type of castable fishing equipment utilizing virtually any type of fishing line and can be secured to the line in any suitable manner known in the art. The illustrated lure B is live bait, such as a worm-type bait. However, it is within the ambit of the present invention to utilize virtually any type of lure, including all forms of live bait (e.g., insects, fish, etc.), as well as any suitable artificial bait (e.g., manmade lures, etc.) including food and food-type products (e.g., vegetables, odorous pastes, etc.). The illustrated fishing tackle 10 broadly includes a fish hook 12 operable to be coupled to the fishing line L and a bait-attachment clip 14 coupled to the hook 12.

The fish hook 12 is configured to hook a biting fish and thereby catch the fish. In more detail, and as shown in FIGS. 1 and 2, the illustrated fish hook 12 includes a barbed end 16. In one manner well known in the art, the barbed end 16 is configured to hook through the fish (e.g., through the fish's mouth when the fish bites or swallows the hook 12, etc.) and once hooked, be generally prevented from pulling out of the fish to thereby catch the fish on the end of the line L for retrieval. The hook 12 further includes an eyelet 18 formed in the opposed end of the hook 12. The eyelet 18 is spaced from the barbed end 16 and is configured to receive the fishing line L or a coupling device, such as a leader (not shown), for coupling the hook 12 to the line L. In one manner known in the art, the illustrated hook 12 includes a shaft section 20 extending between the opposed ends of the hook 12 and a primary bend 22 disposed between the barbed end 16 and the shaft section 20. For purposes that will subsequently be described, the illustrated hook 12 also includes a secondary bend 24 adjacent the eyelet 18 and disposed between the eyelet 18 and the shaft section 20. The hook 12 could be formed of any suitable material and variously dimensioned consistent with the type of fish the hook 12 is being used to fish for, and it is within the ambit of the present invention to utilize virtually any type of fish hook configured for virtually any type of fish (e.g., treble, etc.).

The bait-attachment clip 14 is coupled to the hook 12 and is configured for quickly and securely clamping the bait B to the hook 12. In more detail, and as shown in FIGS. 1-2, the illustrated clip 14 includes a pair of jaws 26 and 28 shiftably coupled together. The jaws 26,28 each present oppositely spaced jaw ends 26a, 26b and 28a, 28b, respectively. The jaw ends 26a,28a are configured to hold the lure B therebetween and accordingly are angled toward each other and at least one of the ends, such as the end 26a, is slightly arcuate. The jaw ends 26b,28b are configured to receive at least one digit of the user's hand to thereby manipulate the jaw ends 26b,28b as detailed below. For purposes that will subsequently be described, formed in the jaw 28 adjacent the jaw end 28b is a hook-receiving aperture 30. The jaws 26,28 are pivotally coupled together by a center pin 32 received between the jaw ends 26a,28a and 26b,28b. In this manner, when the jaw ends 26b,28b are compressed together, the jaw ends 26a,28a are caused to spread apart and vice versa.

In this regard, the jaw ends 26a,28a are shiftable into and out of a variable clamping position as shown in FIGS. 1 and 2 wherein the jaw ends 26a,28a are adjacent one another and are thereby adapted to clamp the bait B there-between. The illustrated jaws 26,28 are yieldably biased into the variable clamping position by a spring wire 34. The spring 34 encircles the pin 32 and the opposed ends of the spring 34 act against the jaw ends 26b,28b to normally force the jaw ends 26b,28b apart. The spring force of the spring wire 34 can be overcome by simply pressing the jaw ends 26b,28b together thereby enabling the lure B to be quickly and easily loaded into, and/or removed from, the clip 14. It will be appreciated that the spring 34 constantly is working to maintain the jaw ends 26a,28a together. In this regard, the clamping position is variable in that the jaw ends 26a,28a are pressed toward each other regardless of their separation. In this manner, various sized lures B can be securely held in the clip 14 as shown in FIG. 1.

The illustrated bait-attachment clip 14 is removably coupled to the hook 12. In this regard, the illustrated fishing tackle 10 includes a flexible sleeve 36 slidably received on the hook 12 and configured to removably couple the bait-attachment clip 14 thereto in an operative position. In more detail, the hook-receiving aperture 30 is configured to be slidably received over the barbed end 16 of the hook 12 yet prevented from sliding over the eyelet 18. In this manner, the clip 14 can be slid onto the hook 12 until the aperture 30 is received on the secondary bend 24 so that the jaw 28 is adjacent to and extends generally parallel with the shaft section 20 of the hook 12 as shown in FIGS. 1 and 2. The sleeve 36 is sized and dimensioned so that the sleeve 36 can be slid over the barbed end 16 of the hook 12 and once on the hook 12 is slidable relative to the hook 12 into a retention position as shown in FIG. 1 and in phantom in FIG. 2. When the sleeve 36 is in the retention position, the sleeve 36 encircles a portion of the shaft section 20 of the hook 12 and the jaw end 28a of the jaw 28 to thereby prevent the jaw 28 from shifting relative to the hook 12. In this regard, the sleeve 36 is a generally elongated, hollow cylinder formed of a flexible material. The material is preferably sufficiently flexible to enable the sleeve 36 to be pulled over the barbed end 16 of the hook 12 and into the retention position without damaging the sleeve 36. However, the material is also preferably sufficiently rigid, or shape-retaining, so as to prevent the jaw 28 from shifting relative to the shaft section 20 when the sleeve 36 is in the retention position. Preferable materials include plastic and/or rubber with polyurethane being most preferred. However, it is within the ambit of the present invention to utilize various alternative configurations for the sleeve 36, for example, a sleeve that is permanently fixed to the clip and hook could be utilized, such as a metal sleeve that is wrapped around the shaft section and jaw and welded thereto. In addition, the bait-attachment clip 14 need not be removably coupled to the hook 12, for example, the clip 14 could be more permanently affixed to, or even integrally formed with, the hook 12.

In operation, the illustrated hook 12 is first coupled to the fishing line L by passing the free end of the line L through the eyelet 18 and then securing the hook 12 on the line L with a suitable knot, such as a fisherman's knot. Next, the bait-attachment clip 14 must be coupled to the hook 12 prior to attaching the bait B into the tackle 10. The barbed end 16 of the hook 12 is slid through the hook-receiving aperture 30 of the jaw 28 and the jaw 28 is slid along the hook 12 until the aperture 30 is positioned on the secondary bend 24 and the jaw 28 extends generally parallel along the shaft section 20 as shown in FIGS. 1 and 2. The sleeve 36 is then slid over the barbed end 16 of the hook 12 and into the retention position wherein the sleeve 36 encircles the a portion of the shaft section 20 and the jaw end 28a of the jaw 28 as shown in FIG. 2. Once the clip 14 is secured in this operating position, the fishing tackle 10 is now ready to receive the bait B.

In order to load the bait B into the tackle 10, the user manipulates the jaw ends 26b,28b with the user's digits to thereby compress the jaw ends 26b,28b together over-coming the spring force in the spring wire 34 thereby causing the opposing jaw end 26a to shift out of the clamping position. With the clip 14 out of the clamping position, one end of the bait B is placed between the jaw ends 26a,28a and the jaw ends 26b,28b are released. When the jaw ends 26b,28b are released, the spring force in the spring wire 34 automatically shifts the jaw end 26a into the clamping position as shown in FIG. 1 thereby securely retaining the bait B in the fishing tackle 10. If desired, particularly in the case of live bait, the free end of the bait B can be secured to the barbed end 16 of the hook 12 in any manner known in the art for a redundant attachment although such redundancy is not necessary and is not preferred. The fishing tackle 10 is now loaded and ready for casting into the water for catching fish in any manner known in the art. If the user desires to change lures for any reason, the above described bait-loading steps are simply reversed and then repeated with the replacement lure.

It will be appreciated that the fishing tackle 10 detailed above provides for a quick yet secure attachment of the bait B to the hook 12 unavailable heretofore. The inventive combination enables a live lure B to be more readily coupled to the hook 12 in a secure manner that does not impair the lure B for example, the bait B need not be impaled on the hook 12 as was necessary with prior art tackle. The secure attachment provided by the clip 14 prevents the fish from “stealing” the lure B off of the hook 12 as is problematic with prior art live bait tackle. The unique clip 14 also allows the lure B to be quickly replaced with a different lure at the fisherman's discretion without the time intensive and undesirable requirement to change hooks.

As indicated above, the fishing tackle 10, including both the hook 12 and the bait-attachment clip 14, could be variously alternatively configured. One such preferred alternative embodiment is the fishing tackle 100 illustrated in FIG. 3. The illustrated tackle 100 broadly includes a fish hook 102 and a bait-attachment clip 104. Unlike the previously described hook 12, the hook 102 does not include a secondary bend, but otherwise the hook 102 is similar to the hook 12. The bait-attachment hook 104, unlike the previously detailed clip 14, is more permanently affixed to the hook 102. In this regard, the clip 104 includes a pair of jaws 106 and 108 with the jaw 108 being integral with the shaft section of the hook 102 and the jaw 106 being shiftable relative thereto. In this manner, the clamping jaw end of the jaw 106 shifts into a clamping position with the shaft section of the hook 102 to secure a lure therebetween. In more detail, the jaw 108 is fixed to the shaft section of the hook 102 between the eyelet and the bend. The jaw 108 could be attached in various manners. For example, the jaw 108 could be placed around the shaft section and welded thereto, or the ends of the jaw 108 could be threadably coupled to the eyelet and the shaft section, etc. It is also within the ambit of the present invention to not utilize a jaw 108 at all, for example, the clip could utilize some type of lug anchored to the hook to receive the center pin for pivotally coupling the jaw 106 to the hook.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

1. (Canceled)

2. The tackle as claimed in claim 15,
said hook including a shaft portion, a barbed end spaced from the shaft portion, and a bend disposed between the shaft portion and the barbed end.

3. The tackle as claimed in claim 2,
said clip including a jaw shiftably coupled relative to the shaft portion,
said jaw being shiftable into and out of a clamping position wherein the jaw is adapted to clamp bait between the jaw and the shaft portion.

4. The tackle as claimed in claim 3,
said jaw being yieldably biased into the clamping position.

5. The tackle as claimed in claim 4,
said clip further including a spring received between the jaw and the shaft portion.

6. The tackle as claimed in claim 5,
said hook further including an eyelet adjacent said shaft portion,
said shaft portion being disposed between said eyelet and said bend,
said spring being positioned generally between said eyelet and said bend.

7-8. (Canceled)

9. The tackle as claimed in claim 13,
said jaws being yieldably biased into the damping position.

10. The tackle as claimed in claim 9,
said clip further including a spring coupled between the jaws and positioned generally between the first and second jaw ends thereof.

11-12. (Canceled)

13. Fishing tackle comprising:
a fish hook; and
a bait-attachment clip fixed relative to the hook,
said clip including first and second jaws shiftably coupled together,
each of said jaws presenting corresponding first and second oppositely spaced jaw ends,
said jaws being shiftable relative to each other into and out of a clamping position wherein the first jaw ends are adjacent one another and the second jaw ends are spaced from one another,
said hook including an eyelet formed in one end thereof and an opposed barbed end spaced from said eyelet,
said hook further including a shaft portion extending between said opposed ends,
said hook further including a first bend disposed between the barbed end and the shaft portion and a second bend disposed between the shaft portion and the eyelet,
said second jaw end of said first jaw defining an aperture therein configured to be slidably received over the barbed end of the hook and prevented from sliding over the eyelet,
said aperture being received on said second bend so that the first jaw is adjacent to and extends generally parallel with the shaft portion of the hook; and
a sleeve encirclingly received around the shaft portion and the first jaw end of the first jaw to retain the first jaw in the generally parallel relationship with the shaft portion.

14. (Canceled)

15. Fishing tackle comprising:
a fish hook;
a bait-attachment clip fixed relative to the hook; and
coupling means for removably coupling the clip to the hook,
said coupling means including a flexible sleeve slidably received around at least a portion of the hook and at least a portion of the clip.

16. Fishing tackle for coupling a lure to a fishing line, said tackle comprising:
a fish hook operable to be coupled to the fishing line;
a clip removably coupled to the hook and including a first and a second jaw,
said first and second jaws being shiftable relative to each other into and out of a clamping position wherein the jaws are adapted to hold the lure; and
a sleeve received on the hook and slidable relative to the hook and at least one of the jaws into a retention position wherein the sleeve encircles at least a portion of the hook and at least a portion of said at least one jaw to thereby removably couple the clip to the hook.

17. The tackle as claimed in claim 16,
said jaws being yieldably biased into the clamping position.

18. The tackle as claimed in claim 17,
said clip including a spring disposed between said jaws for yieldably biasing the jaws into the clamping position.

19. The tackle as claimed in claim 16,
said sleeve comprising an elongated hollow cylinder.

20. The tackle as claimed in claim 19,
said sleeve being formed of a flexible material.

21. The tackle as claimed in claim 20,
said material being substantially comprised of polyurethane.

22. The tackle as claimed in claim 16,
said at least one jaw being said first jaw,
said sleeve generally preventing said first jaw from shifting relative to the hook and the second jaw when the sleeve is in the retention position.

23. The tackle as claimed in claim 22,
said hook including a shaft portion, a barbed end spaced from the shaft portion, and a bend disposed between the shaft portion and the barbed end.

24. The tackle as claimed in claim 23,
said at least a portion of the hook comprising said shaft portion.

25. The tackle as claimed in claim 24,
said second jaw being positioned between said barbed end and said shaft portion when the jaws are in the clamping position and the sleeve is in the retention position.

26. The tackle as claimed in claim 16,
said hook including an eyelet formed in one end thereof and an opposed barbed end spaced from said eyelet,
said hook further including a shaft portion extending between said opposed ends,
said hook further including a first bend disposed between the barbed end and the shaft portion and a second bend disposed between the shaft portion and the eyelet.

27. The tackle as claimed in claim 26,
said at least one jaw being said first jaw,
said first jaw including a first end and an opposite spaced second end,
said first jaw end defining an aperture therein configured to be slidably received over the barbed end of the hook and prevented from sliding over the eyelet.

28. The tackle as claimed in claim 27,
said at least a portion of said first jaw being said second jaw end,
said aperture being received on said second bend when the sleeve is in the retention position so that the first jaw is adjacent to and extends generally parallel with the shaft portion of the hook.

29. (Canceled)

30. The method as claimed in claim 34,
step (b) being performed after step (a).

31. The method as claimed in claim 30;
(c) unclamping the first lure from the clip and removing the first lure from the clip; and
(d) after step (c), clamping a second lure in the clip.

32. The method as claimed in claim 34,
said first lure comprising live bait.

33. The method as claimed in claim 32; and
(c) coupling a portion of the first lure to the hook so that the first lure is secured to both the clip and the hook.

34. A method of baiting a fishing hook comprising the steps of:
(a) coupling a lure-attachment clip to the hook; and
(b) clamping a first lure in the clip,
step (a) including the steps of coupling one end of the clip to the hook and then sliding a flexible sleeve over the hook and over at least a portion of the other end of the clip to thereby removably couple the clip to the hook.

35. The method as claimed in claim 34,
step (a) including the step shiftably coupling a clip jaw relative to the hook,
step (b) including the step of clamping the lure between the clip jaw and a portion of the hook so that the lure is engagingly received between the jaw and the portion of the hook.
